(19) United States
(12) Patent Application Publication
(10) Pub. No.: US 2016/0280593 A1
(43) Pub. Date: Sep. 29, 2016

(54) STRENGTHENED GLASS SUBSTRATES

(71) Applicant: EMPIRE TECHNOLOGY DEVELOPMENT LLC, Wilmington, DE (US)

(72) Inventors: Motoyuki Toki, Kyoto (JP); Ayami Dan, Kyoto (JP)

(73) Assignee: EMPIRE TECHNOLOGY DEVELOPMENT LLC, Wilmington, DE (US)

(21) Appl. No.: 15/035,758

(22) PCT Filed: Nov. 11, 2013
(86) PCT No.: PCT/US13/69471

§ 371 Date: May 11, 2016

(51) Int. Cl. C03C 23/00; C03C 17/30

(52) U.S. Cl. CPC C03C 23/002; C03C 17/30; C03C 2218/116

(57) ABSTRACT

Methods of making a strengthened ultra-thin glass substrate may include forming a film including a volume expanding composition on a glass substrate, and treating the film under conditions sufficient to cause volume expansion of the volume expanding composition, thereby generating internal compressive stress in the film such that compressive stress is imparted onto the substrate and a fracture strength of the substrate is improved. In some embodiments, the volume expanding compound is converted into a different compound with a larger volume When it is treated under sufficient conditions.

### BACKGROUND

Smartphones, tablet PCs, and devices with liquid crystal displays (LCDs) have recently formed large markets, become popular types of mobile terminals, and dramatically changed the lifestyles of users. However, there remains a need to reduce the weight of these devices. The weight of LCD devices can be dramatically reduced by using ultra-thin glass substrates in place of conventional glass substrates. Conventional glass substrates of LCD devices can have thicknesses of about 30 μm and can make up about 25% of the weight of the LCD device. In contrast, ultra-thin glass substrates can have a thickness of 100 μm or less, However, as glass substrates become thinner, they can also become more susceptible to cracking Further, ultra-thin glass substrates can be difficult to handle in the manufacturing process. Therefore, it is desirable to produce ultra-thin glass substrates that are strengthened, less susceptible to cracking, have improved impact resistance, and have improved fracture strengths.

### SUMMARY

In some embodiments, a method for making a strengthened glass substrate can include providing a glass substrate having a thickness of 100 μm or less. The method can further include forming a first film having a thickness of about 5 μm to 30 μm on a top surface of the glass substrate, the first film comprising a first volume expanding composition. The method can fluffier include treating the substrate comprising the first film under conditions sufficient to cause volume expansion of the first volume expanding composition, thereby generating internal compressive stress in the first film such that compressive stress is imparted onto the glass substrate and a fracture strength of the glass substrate is improved.

In some embodiments, a method for making a strengthened glass substrate can include providing a glass substrate having a thickness of 100 μm or less. The method can further include forming a first film on a top surface of the glass substrate, the first film comprising a volume-expanding monomer. The method can timber include causing the monomer in t le first film to polymerize, thereby expanding the volume of the first film and generating internal compressive stress in the first film such that compressive stress is imparted onto the glass substrate and a fracture strength of the glass is improved.

In some embodiments, a strengthened glass substrate can be formed by a process, wherein the process includes providing a glass substrate having a thickness of 100 μm or less. The process can further include forming a film comprising a volume expanding composition on one or both surfaces of the glass substrate. The process can further include treating the film-coated substrate under conditions sufficient to cause volume expansion of the composition, thereby generating internal compressive stress in the film such that compressive stress is imparted onto the glass substrate and a fracture strength of the glass substrate is improved.

In some embodiments, a strengthened glass substrate can include a glass sheet having a thickness of 100 μm or less. The strengthened glass substrate can further include a film comprising a volume expanded composition, the film being disposed on one or both surfaces of the glass sheet, wherein the film is under internal compressive stress such that compressive stress is imparted onto the glass sheet and a fracture strength of the glass sheet is improved.

In some embodiments, a device can include a strengthened glass substrate. The strengthened glass substrate can include a glass sheet having a thickness of 100 μm or less. The strengthened glass substrate can further include a film comprising a volume expanded composition, the film being disposed on one or both surfaces of the glass sheet, wherein the film is under internal compressive stress such that compressive stress is imparted onto the glass sheet and a fracture strength of the glass sheet is improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates an exploded perspective view of a strengthened ultra-thin glass substrate.

FIG. 2 illustrates a cross section of a strengthened ultra-thin glass substrate.

FIG. 3 illustrates a method for making a strengthened ultra-thin glass substrate.

FIG. 4 illustrates a chemical reaction converting a volume expanding compound.

FIG. 5 illustrates a chemical reaction converting another volume expanding compound.

FIG. 6 illustrates a chemical reaction polymerizing a volume expanding monomer.

FIG. 7 illustrates the results of a three-point bending test performed on two samples of a glass substrate.

FIG. 8 illustrates the results of a three-point bending test performed on two samples of a substrate including a film on methylphenylpolysilane formed on one side of the substrate before heat treatment.

FIG. 9 illustrates the results of a three-point bending test performed on two samples of a substrate including a film of methylphenylpolysilane formed on one side of the substrate heated at 200° C.

FIG. 10 illustrates the results of a three-point bending test performed on two samples of a substrate including a film of methylphenylpolysilane formed on one side of the substrate heated at 220° C.

FIG. 11 illustrates the results of a three-point bending test performed on two samples of a substrate including a film of methylphenylpolysilane formed on one side of the substrate heated at 250° C.

FIG. 12 illustrates the results of a three-point bending test performed on two samples of a substrate including a film of methylphenylpolysilane formed on both sides of the substrate heated at 220° C.

### DETAILED DESCRIPTION

In the following detailed description, reference is made to the accompanying drawings, which form a part hereof in the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

In order to strengthen ultra-thin glass substrates, the substrate can be coated with a film including a volume expanding composition. In some embodiments, treating the substrate causes volume expansion of the composition, thereby generating internal compressive stress as the composition expands in volume. Thus, compressive stress can be imparted onto the glass substrate and the fracture strength of the glass can be improved.

In some embodiments, the volume expanding composition includes polysilane, which can be converted to polycarbosilane when heated. Because polycarbosilane has a larger volume than polysilane, heating polysilane causes volume expansion, according to some embodiments. Thus, some embodiments include an ultra-thin glass substrate with a film of polycarbosilane formed thereon, which was obtained by heating polysilane. Other examples of volume expanding compositions include methylphenylpolysilane, which can be converted to methylphenylpolysiloxane when heated, and a monomer such as that illustrated in FIG. 6, which can be converted to an open-ring epoxy polymer when polymerized.

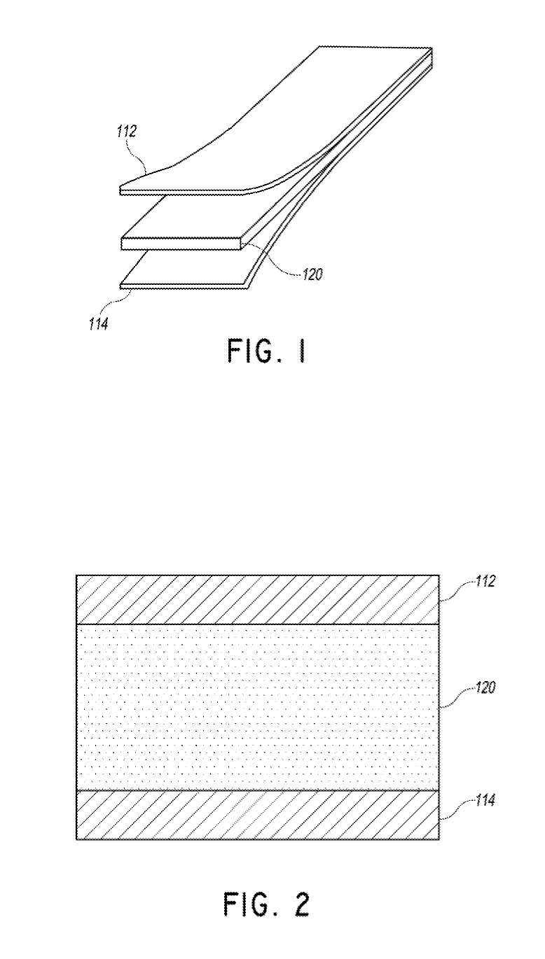

FIG. 1 illustrates a perspective view, and FIG. 2 illustrates a cross-sectional view, of a strengthened ultra-thin glass substrate according to some embodiments. Referring to FIGS. 1 and 2, an ultra-thin glass substrate 120 includes a top film 112 and a bottom film 114. In other embodiments, an ultra-thin glass substrate 120 includes a film 110 on only one side of the substrate 120, such that the substrate includes only a top film 112 or only a bottom film 114. The film 112, 114 can be under internal compressive stress, such that compressive stress is imparted onto the glass substrate 120. Therefore, a fracture strength of the ultra-thin glass substrate 120 can be improved against external threes such as bending stresses or dropping impacts, thereby reducing susceptibility of the glass substrate 120 to cracking.

In order to generate internal compressive stress in the films 112, 114, a volume expanding composition can be used to make the films 112, 114. For example, a volume expanding composition can include a volume expanding compound such as polysilane, methylphenylpolysilane, and/or a monomer such as the monomer illustrated in FIG. 6, all of which expands in volume when treated under conditions effective to result in the expansion. In some embodiments, internal compressive stress is generated as the volume expanding composition expands. The conditions effective to result in the expansion may include heating to a temperature of at least about 50 ° C., for example about 50° C. to about 500° C., including about 50° C., about 100° C. about 150° C., about 200° C., about 250° C., about 300° C., about 350° C., about 400° C., about 450° C., about 500° C., or a temperature between any of these values. In some embodiments, the heating occurs at a temperature of about 80° C. to about 250° C. In some embodiments, the heating occurs at a temperature of about 220° C. In some embodiments, the heating occurs at a temperature of at least about 350° C. In some embodiments, the heating occurs at a temperature of about 350° C. to about 450° C. In some embodiments, the heating occurs at a temperature of about 400° C. For example, when a film of polysilane, which is a volume expanding composition, is heated to a temperature of about 50° C. to about 500° C., internal compressive stress can be created as the polysilane film 112, 114 expands in volume. Other volume expanding compositions can similarly generate internal compressive stress when treated under conditions effective to result in the volume expansion of the compositions. Internal compressive stress in the film 112, 114 imparts compressive stress onto the glass substrate 120, thereby improving a fracture strength of the glass substrate 120.

In addition, treating the volume expanding composition can cause a reaction converting the volume expanding compound into a different compound. For example, heating polysilane in an inert atmosphere (for example, nitrogen (N₂), argon (Ar), helium (He), and so on) can convert it into polycarbosilane. In some embodiments, these reactions can generate internal compressive stress because the products of the chemical reaction are larger in volume than that of the reactants. Accordingly, in some embodiments, the material of the film 112, 114 includes a compound (for example, a product) that is obtained by treating a volume-expanding composition (for example, a reactant) under conditions sufficient to cause volume expansion.

Generally, there is sometimes a trade-off between thickness and weight. Thus, it is often desirable for the glass substrate 120 and the film 112, 114 to be as thin as possible. In some embodiments, the ultra-thin glass substrate 110 can have a thickness of about 100 um or less, including about 5 μm, about 10 μm, about 20 μm, about 30 μm, about 40 μm, about 50 μm, about 60 μm, about 70 μm, about 80 μm, about 90 μm, about 100 μm, or a thickness between any of these values. For example, the thickness of the glass substrate 110 can be about 30 μm. In addition, the thickness of the film 112, 114 can be about 5 μm to about 30 μm in some embodiments. For example, the thickness of the film 112, 114 can be about 20 μm. In some embodiments, the thickness of the top film 112 and the bottom film 114 can be the same, In other embodiments, the thickness of the top film 112 and the bottom film 114 can be different.

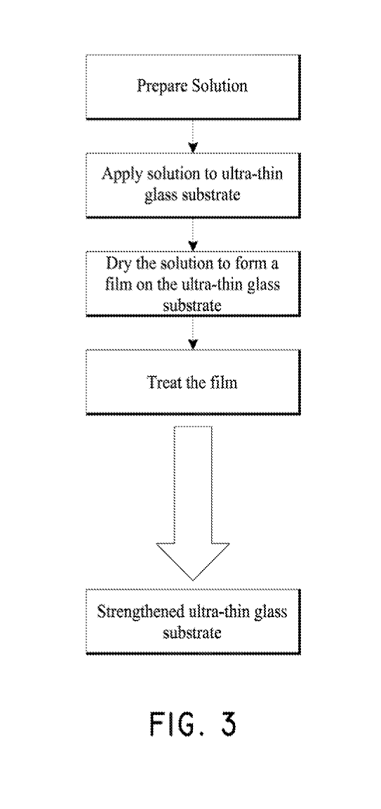

FIG. 3 illustrates a method of making a strengthened ultra-thin glass substrate according to some embodiments. Referring to FIG. 3, a method of making a strengthened ultra-thin glass substrate can include preparing a solution, applying the solution to an ultra-thin glass substrate 120, drying the solution to form a film 112, 114 on the glass substrate 120, and treating the film 110, thereby producing a strengthened ultra-thin glass substrate. In some embodiments, the solution can be prepared by dissolving a volume-expanding compound in at least one organic solvent, such as toluene or tetrahydrofuran (THF). The volume-expanding compound can be a compound that, when treated, expands in volume. Some examples of volume-expanding compounds include polysilane, methylphenylpolysilane, and a monomer as described herein. The solution including the volume expanding composition can be applied to one or both sides of an ultra-thin glass substrate 120 by spin-coating, dipping, flow-coating, or any other suitable method. In some embodiments, the same solution is applied to both sides of the substrate 120. After the solution is applied to the glass substrate 120, the solution can be dried by natural air-drying or by using a drying machine at a temperature of about 50° C. to about 100° C., for example about 50° C., about 60T, about 70° C., about 80° C., about 90° C., about 100° C. or a temperature between any of these values. By applying and drying the solution on the glass substrate 120, a film 112, 114 including a volume expanding composition can be formed.

In some embodiments, the film 112, 114 can be treated such that the volume expanding composition expands in volume. As the volume expands, internal compressive stress can be generated in the turn 112, 114, thereby imparting compressive stress onto the glass substrate 120 and improving the fracture strength of the glass substrate 120 in some embodiments, the compound expands in volume after treating it because the composition is converted into a different compound with a larger volume.

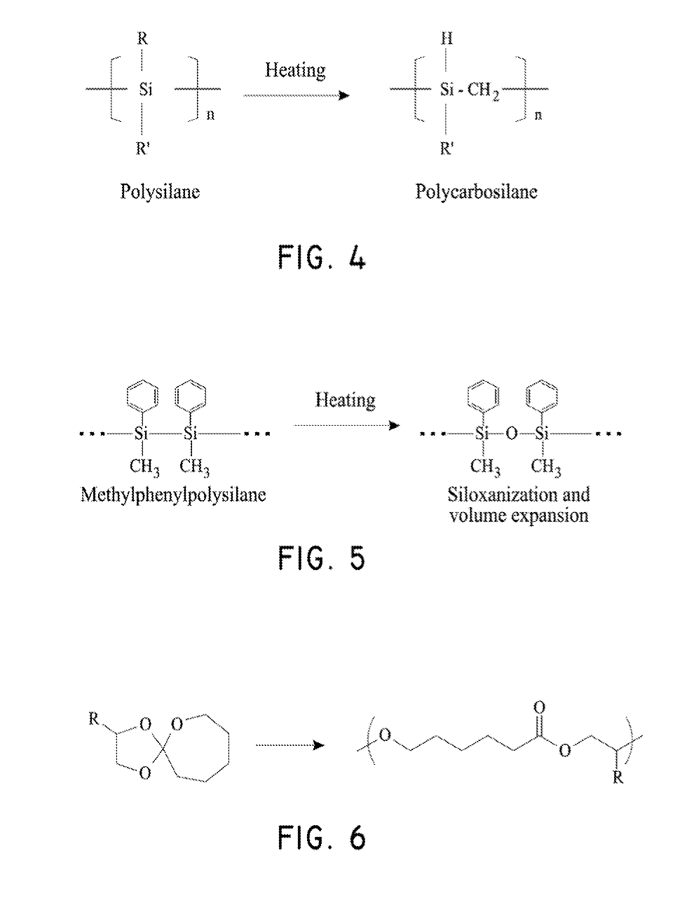

One example of a volume expanding compound is polysilane. FIGS. 4-5 illustrate two examples of polysilane reactions which cause volume expansion and generate internal compressive stress. Referring to FIG. 4, a film 112, 114 of polysilane, which may be formed on an ultra-thin glass substrate 120, can be heated under the conditions effective to convert polysilane into polycarbosilane, thereby causing volume expansion. Accordingly, some embodiments include a glass substrate 120 with a film 112, 114 of polycarbosilane, which was obtained by heating a film 112, 114 of polysilane on the glass substrate 120. The film 112, 114 of polycarbosilane can be under internal compressive stress, thus imparting compressive stress onto the glass substrate 120 and improving a fracture strength of the substrate 120.

In some embodiments, the conditions under which volume expansion of a volume expanding composition such as polysilane can include heating at a temperature of about 50° C. to about 500° C. as described above. In an embodiment, the heating can be performed at a temperature of about 350° C. to 450° C. The atmosphere in which the heating occurs can be an inert one that has at least one inert gas. The heating can occur for a time period of about 30 minutes to about 120 minutes, including, about 30 minutes, about 50 minutes, about 70 minutes, about 90 minutes, about 120 minutes, or a time period between any of these values. For example, the polysilane film can be heated at a temperature of about 400° C. in addition, the atmosphere in which the heating is conducted can include nitrogen (N₂), argon (Ar), helium (He), any other suitable inert gas, or combinations thereof. Besides heating, ultraviolet (UV) light can be used to result in the volume expansion. In some embodiments, the conditions suitable for resulting in the volume expansion may include UV irradiation. For example, to convert polysilane to polycarbosilane and cause volume expansion of the polysilane film 112, 114, the polysilane may be converted to polycarbosilane under UV light irradiation with a wavelength of about 315 nm for about 10 minutes to about 60 minutes in ambient air.

FIG. 5 illustrates another polysilane reaction which causes volume expansion and generates internal compressive stress, thereby improving a fracture strength of a glass substrate 120. In some embodiments, the polysilane can be converted to a polysiloxane to result in the volume expansion. Specifically, in some embodiments the polysilane that can be used is methylphenylpolysilane, which can be converted to methylphenylpolysiloxane. Referring to FIG. 5, a film 112, 114 of methylphenylpolysilane, which may be formed on a glass substrate 120, can expand in volume when it is siloxanized (for example, when siloxane bonds are formed) by heating it under conditions effective to cause the volume expansion. Siloxanization can convert methylphenylpolysilane to methylphenylpolysiloxane. Accordingly, some embodiments include a glass substrate 120 with a film 112, 114 of methylphenylpolysiloxane, which is obtained by heating a film 112, 114 of methylphenylpolysilane. The film 112, 114 of methylphenylpolysiloxane can be under internal compressive stress, such that a fracture strength of the glass substrate 120 is improved.

Some conditions under which methylphenylypolysilane can be converted to methylphenylpolysiloxane include a temperature of about 50° C. to 500° C. as described above. The heating may occur in an atmosphere containing oxygen (O₂) or in an atmosphere containing a mixture of gases that includes oxygen (for example, air), and for a time period of about 30 minutes to about 120 minutes as described above. For example, the heating can occur for a period of about 30 minutes to about 60 minutes, in some embodiments, the film of methylphenylpolysilane is heated at a temperature of about 80° C. to about 250 C. For example, methylphenylpolysilane can be heated at a temperature of about 220° C. In addition, the heating can be conducted in the presence of oxygen (O₂) or in the presence of a mixture of gases that includes oxygen (for example, air). Besides heating, volume expansion can be caused by illuminating a film of methylphenylpolysilane with UV light. In some embodiments, methylphenylpolysilane may be converted to methylphenylpolysiloxane under UV light irradiation with a wavelength of about 315 nm for about 10 minutes to about 60 minutes in ambient air.

FIG. 6 illustrates another example of a reaction which causes volume expansion and generates internal compressive stress, thereby strengthening an ultra-thin glass substrate 120. Specifically, one example of a volume expanding compound is the monomer illustrated in FIG. 6. Generally, the volume of monomers reduces during polymerization. In contrast, the volume of the monomer illustrated in FIG. 6 expands when it is polymerized to an open-ring epoxy polymer. The “R” in FIG. 6 represents an alkyl group. Thus, some embodiments include an ultra-thin glass substrate 120 with a film 112, 114 of an open-ring epoxy polymer, which was obtained by polymerizing the monomer. The monomer can be polymerized by introducing an initiating agent or heating the monomer in order to cause polymerization. The film 112, 114 of the open-ring epoxy polymer can be under internal compressive stress, thus improving a fracture strength of the glass substrate 120, due to volume expansion of the monomer when polymerized.

In addition to the compounds illustrated in FIGS. 4-6, other volume expanding compounds are also possible. Further, in addition to compressive stress, the film 112, 114 can strengthen the glass substrate 120 and prevent cracking of the glass substrate 120 in other ways as well. For example, the film 112, 114 can act as a protective layer.

In some embodiments, a top film 112 and a bottom film 114 is formed on the substrate 120, then both the top film 112 and the bottom film 114 can be treated at one time. In other embodiments, the top film 112 and the bottom film 114 can be treated separately. For example, a top film 112 can be formed, then the top film 112 can be treated. Next, a bottom film 114 can be formed, then the bottom film 114 can be treated. In some embodiments, only a top film 112 or a bottom film 114 may be formed on only one side of the substrate 120.

Multiple devices can incorporate the strengthened ultra-thin glass substrates described herein. For example, the glass substrates can be used in LCD devices such as cell phones, tablet PCs, or other mobile IT devices. The devices can be built according to methods known in the art. The components can include a color filter, a polarizer, a back light, a liquid crystal layer, and other components known in the art. In place of the glass substrates currently used with LCD devices, the strengthened ultra-thin glass substrates described herein can be used. Thus, the weight of the devices can be dramatically reduced, while exhibiting improved resistance to cracking.

### EXAMPLE 1

### Preparing a Strengthened Ultra-Thin Glass Substrate Having One-Side Coating

Methylphenylpolysilane (manufactured by Osaka Gas Chemicals (Osaka, Japan)), represented by formula (1) shown below, was dissolved in tetrahydrofuran (THF) to prepare a 40% solution.

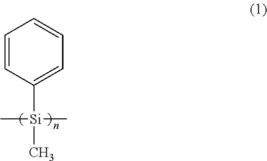

The methylphenylpolysilane solution was applied to one side of an ultra-thin glass substrate having a thickness of 100 μm (manufactured by Nippon Electric Glass (Shiga, Japan)) by spin coating. Spin coating was performed for 1 second at 100 RPM, then for 3 seconds at 500 RPM. After applying the methlyphenypolysilane solution to one side of the glass substrate, the solution was dried for 10 minutes in a drying machine at 80° C., thereby forming a methylphenylpolysilane film. The film thickness, measured by using a micrometer, was about 20 μm. The glass substrate and the methylphenylpolysilane film formed by the method described above was heated for 30 minutes in air on a hotplate at a temperature of 200° C. thereby siloxanizing the methylphenylpolysilane.

In order to confirm whether siloxanization was caused by the heat treatment, FR-IR (ATR) analysis of the film before and after heating was performed. Based on the FT-IR spectra, it was confirmed that siloxanization occurred when the film was subjected to the heat treatment. Thus, a strengthened ultra-thin glass substrate was obtained.

The strengthened ultra-thin glass substrate is used by building: it into a device, such as a display device, according to methods well known in the art. Examples of such devices include a cell phone, tablet PC, or other mobile IT devices. The strengthened ultra-thin glass substrate is built with supporting components such as a color filter, a polarizer, a back light, and a liquid crystal layer. The device is then used in normal operation while exhibiting improved resistance to cracking.

### EXAMPLE 2

### Preparing a Strengthened Ultra-Thin Glass Substrates Having One-Sided Coating

A strengthened ultra-thin glass substrate was obtained in the same manner as in Example 1 except that the methylphenylpolysilane film was heated at a temperature of 220° C. Heating methylphenylpolysilane at 220° C generated sufficient internal compressive stress due to formation of methylphenylpolysiloxane and as a result, the fracture strength of the glass substrate was improved, as indicated by the data described in Example 5.

The strengthened ultra-thin glass substrate is used by building it into a device, such as a display device, according to methods well known in the art. Examples of such devices include a cell phone, tablet PC, or other mobile IT devices. The strengthened ultra-thin glass substrate is built with supporting components such as a color filter, a polarizer, a back light, and a liquid crystal layer. The device is then used in normal operation while exhibiting improved resistance to cracking.

### EXAMPLE 3

### Preparing a Strengthened Ultra-Thin Glass Substrates Haying One-Side Coating

A strengthened ultra-thin glass substrate was obtained in the same manner as in Example 1 except that the methylphenylpolysilane film was heated at a temperature of 250° C. The resulting substrate included a film of methylphenylpolysiloxane, which was under internal compressive, stress and thereby strengthened the glass substrate.

To use the strengthened ultra-thin glass substrate, it is built into a device, such as a display device, according to methods well known in the art. Examples of such devices include a cell phone, tablet PC, or other mobile IT devices. The strengthened ultra-thin glass substrate is built with supporting components such as a color filter, a polarizer, a back light, and a liquid crystal layer. The device is then used in normal operation while exhibiting improved resistance to cracking.

### EXAMPLE 4

### Making a Strengthen Ultra-Thin Glass Substrates Having Both-Side Coating

A glass substrate coated with a film of methylphenylpolysilane was made according to the method of Example 1, except that the glass was coated on both sides and heated for 30 minutes on a hotplate at a temperature of 220° C., thereby siloxanizing the methylphenylpolysilane on both sides of the substrate.

In order to confirm whether siloxanization was caused by the heat treatment, FT-IR (ATR) analysis of the film before and after heating was performed. Based on the FT-IR spectra, it was confirmed that siloxanization occurred when the film was subjected to the heat treatment. Thus, a strengthened ultra-thin glass substrate was obtained.

The strengthened ultra-thin glass substrate is used by building it into a device, such as a display device, according to methods well known in the art. Examples of such devices include a cell phone, tablet PC, or other mobile IT devices. The strengthened ultra-thin glass substrate is built with supporting components such as a color filter, a polarizer, a back light, and a liquid crystal layer. The device is then used in normal operation while exhibiting improved resistance to cracking.

### EXAMPLE 5

### Evaluation of Strength

A three-point bending test using a universal testing machine was conducted on the glass substrates obtained in Examples 1-4. For each example, two samples of glass substrates were obtained.

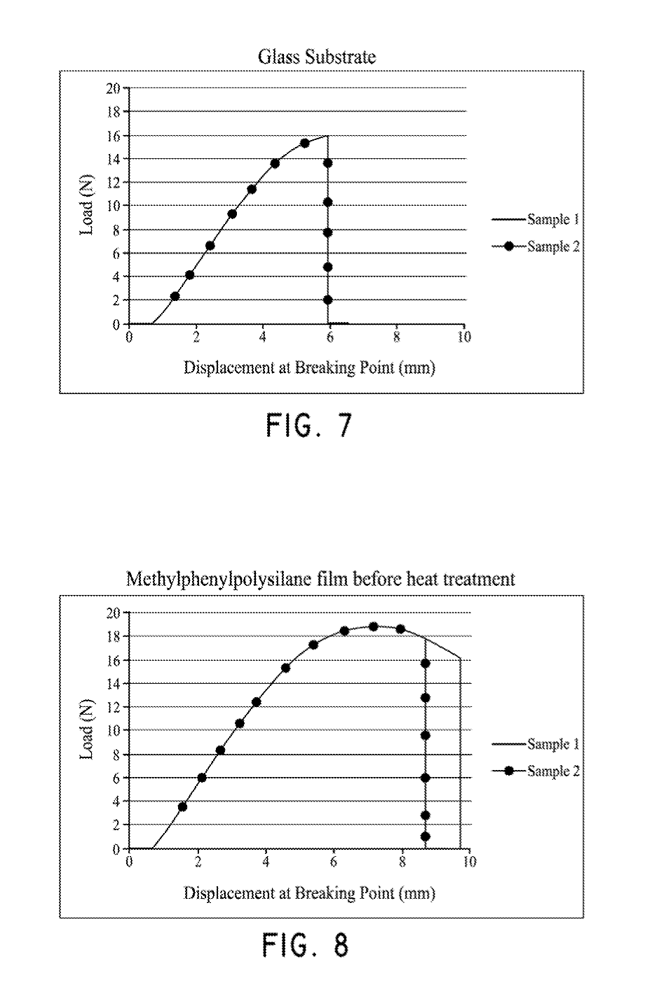

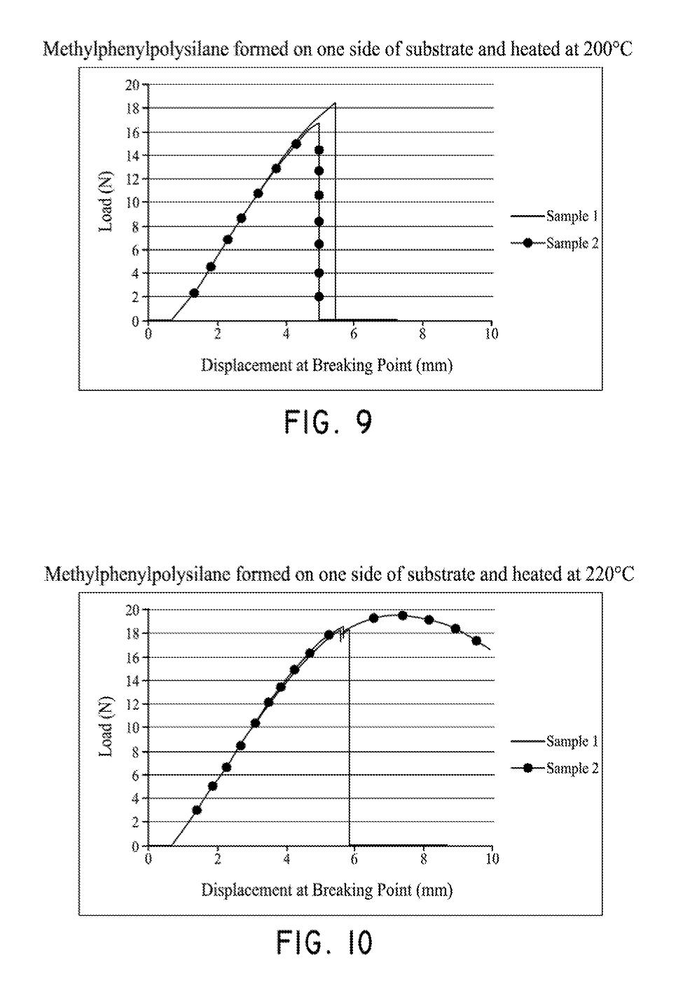

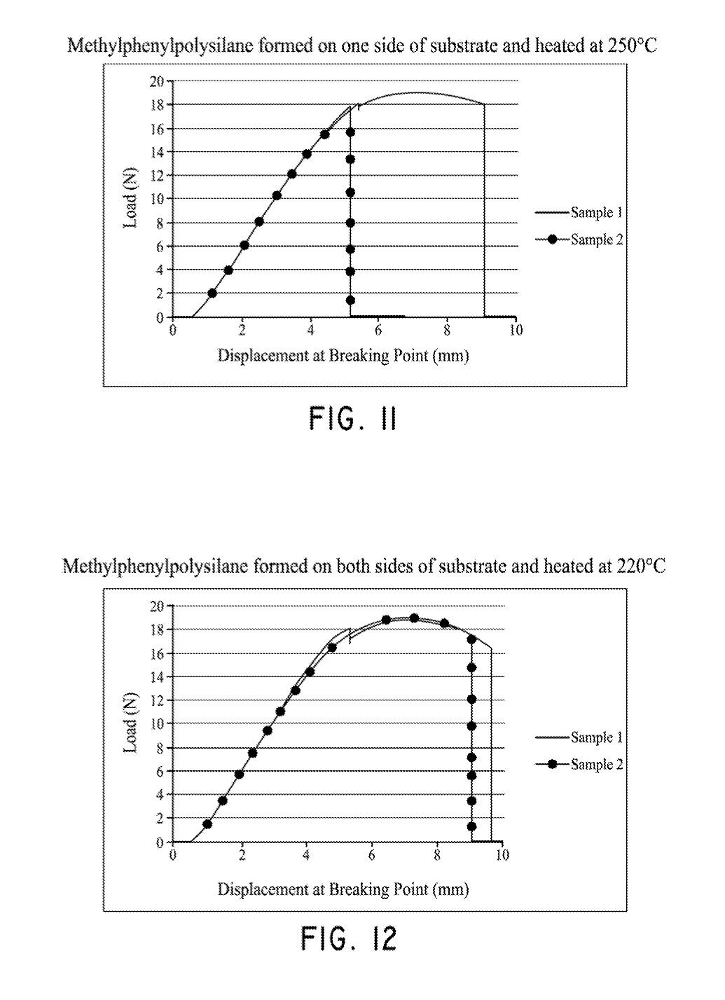

The three-point bending test was conducted on the two samples from each Example and the results were averaged. A three-point bending test was also conducted on (I)a glass substrate without a film and (2) a glass substrate with a methylphenylpolysilane film on one side of the substrate that was dried at 80° C. without heat treatment. The three-point bending test was conducted on two samples for each type of substrate and the results were averaged. The results of the tests are illustrated in FIGS. 7-12. Tables 1-2 below summarize the results.

TABLE 1
Maximum Load (N)

| | | Methyl- | Example 1 | Example 2 | Example 3 | Example 4 |
|---|---|---|---|---|---|---|
| | | phenyl- | (film on one | (film on one | (film on one | (film on both |
| | | polysilane | side of | side of | side of | sides of |
| | | film | substrate | substrate | substrate | substrate |
| | Glass | without heat | heated at | heated at | heated at | heated at |
| | Substrate | treatment | 200° C.) | 220° C.) | 250° C.) | 220° C.) |
| Sample 1 | 15.94 | 18.65 | 18.36 | 18.30 | 17.50 | 18.96 |
| Sample 2 | 15.99 | 18.88 | 16.69 | 18.27 | 17.82 | 19.19 |
| Average | 15.97 | 18.77 | 17.53 | 18.29 | 17.66 | 19.07 |

TABLE 2
Displacement at breaking point (mm)

| | | Methyl- | Example 1 | Example 2 | Example 3 | Example 4 |
|---|---|---|---|---|---|---|
| | | phenyl- | (film on one | (film on one | (film on one | (film on both |
| | | polysilane | side of | side of | side of | sides of |
| | | film | substrate | substrate | substrate | substrate |
| | Glass | without heat | heated at | heated at | heated at | heated at |
| | Substrate | treatment | 200° C.) | 220° C.) | 250° C.) | 220° C.) |
| Sample 1 | 5.94 | 9.69 | 5.44 | 5.88 | 5.20 | 9.61 |
| Sample 2 | 5.91 | 8.66 | 4.97 | 5.51 | 5.19 | 9.03 |
| Average | 5.93 | 9.18 | 5.21 | 5.70 | 5.20 | 9.32 |

The results depicted in FIGS. 7-12 and Tables 1-2 indicate that ultra-thin glass substrates having a methylphenylpolysilane film subjected to heat treatment were stronger and less susceptible to cracking compared to untreated glass substrates without a methylphenylpolysilane film. The glass substrate coated with the methylphenylpolysilane film on one side of the substrate that was dried at 80° C. without heat treatment exhibited cracking after drying, and before the three-point bending test was conducted. Therefore, results obtained in Table 1 and Table 2 for the cracked glass substrate may not be representative of an uncracked glass substrate coated with the non-heat treated methylphenylpolysilane film in addition, ultra-thin glass substrates with a methylphenylpolysilane film on one side of the substrate heated at 220° C. were able to withstand a larger maximum load than those heated at other temperatures (for example, 200° C. and 250° C.). Furthermore, the results indicate that ultra-thin glass substrates with a methylphenylpolysilane film on both sides of the substrate were able to withstand a larger maximum load than those with a film on only one side of the substrate.

Thus, these results indicate that heating a film of methylphenylpolysilane on an ultra-thin glass substrate strengthened the ultra-thin glass substrate against external forces such as bending stresses and dropping impacts.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C. etc.” is used, in general such a construction is intended in the sense one having skill in the art would understand the convention (e.g., “a system having at least one of A, B, and C” would include but not be limited to systems that have A alone, B alone. C alone, A and B together, A and C together, B and C together, and/or A, B, and C together, etc.). In those instances where a convention analogous to “at least one of A, B, or C. etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be with the true scope and spirit being indicated by the following claims.

1. A method for making a strengthened glass substrate, the method comprising:
providing a glass substrate having a thickness of 100 μm or less;
forming a first film having a thickness of about 5 μm to 30 μm on a top surface of the glass substrate, the first film comprising a first volume expanding composition; and
treating the substrate comprising the first film under conditions sufficient to cause volume expansion of the first volume expanding composition, thereby generating an internal stress in the first film such that the internal stress is imparted onto the glass substrate and a fracture strength of the glass substrate is improved.

2-3. (canceled)

4. The method of claim 1, wherein treating the substrate includes one or more of heating the substrate and illuminating the substrate with Ultraviolet (UV) light.

5-6. (canceled)

7. The method of claim 1, wherein the first volume expanding composition comprises polysilane.

8. The method of claim 7, wherein the polysilane is methylphenylpolysilane.

9. The method of claim 1, further comprising:
forming a second film on a bottom surface of the substrate, the second film comprising a second volume expanding composition.

10.-14. (canceled)

15. The method of claim 9, wherein the second volume expanding composition comprises polysilane.

16. The method of claim 15, wherein the polysilane is methylphenylpolysilane.

17-28. (canceled)

29. A method for making a strengthened glass substrate, the method comprising:
providing a glass substrate having a thickness of 100 μm or less;
forming a first film on a top surface of the glass substrate, the first film comprising a volume-expanding monomer, and
causing the monomer in the first film to polymerize, thereby expanding the volume of the first film and generating an internal stress in the first film such that the internal stress is imparted onto the glass substrate and a fracture strength of the glass is improved.

30. The method of claim 29, wherein the glass substrate has a thickness of about 30 μm.

31. The method of claim 29, wherein forming the first film on the top surface comprises:
preparing a solution comprising the volume-expanding monomer by dissolving an amount of the first volume-expanding monomer in an organic solvent;
applying the solution to the substrate by spin-coating, dipping or flow-coating; and
drying the solution.

32. The method of claim 29, wherein causing the monomer to polymerize comprises one or more of introducing an initiating agent to the first film and illuminating the polymer with UV light.

33. The method of claim 29, further comprising:
forming a second film on a bottom surface of the glass substrate, the second film comprising the volume-expanding monomer; and
causing the monomer in the second film to polymerize, thereby expanding the volume of the second film and generating internal compressive stress in the second film such that further compressive stress is imparted onto the glass substrate and the fracture strength of the glass substrate is thither improved.

34. The method of claim 33, wherein forming the second film on the bottom surface comprises:
applying the solution to the substrate by one or more of spin-coating, dipping and flow-coating; and
drying the solution.

35. The method of claim 29, wherein the monomer in the first film and the monomer in the second film polymerizes to an open-ring epoxy polymer as shown below; 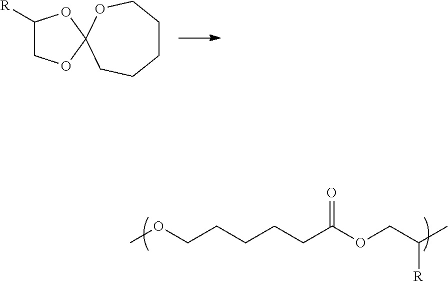
wherein R is an alkyl group.

36. A strengthened glass substrate formed by a process, the process comprising:
providing a glass substrate having a thickness of 100 μm or less;
forming a film comprising a volume expanding composition on one or both surfaces of the glass substrate:
treating the film-coated substrate under conditions sufficient to cause volume expansion of the composition, thereby generating an internal stress in the film such that the internal stress is imparted onto the glass substrate and a fracture strength of the glass substrate is improved.

37. The strengthened glass substrate formed by the process of claim 36,
wherein forming the film comprises:
applying a solution comprising the volume expanding composition to one or both surfaces of the substrate; and
drying the solution.

38. The strengthened glass substrate formed by the process of any one of claim 36, wherein the volume expanding composition comprises polysilane.

38. The strengthened glass substrate formed by the process of claim 38, wherein treating the substrate comprises heating the substrate under conditions sufficient to cause partial oxidation of the polysilane such that polysilane is converted into polysiloxane.

40. The strengthened glass substrate formed by the process of claim 38, wherein heating the substrate comprises heating the substrate under conditions sufficient to convert the polysilane into polycarbosilane.

41. The strengthened glass substrate formed by the process of any of claim 36, wherein the composition comprises a monomer, and treating the substrate comprises treating the substrate under conditions sufficient to cause polymerization of the monomer.

42. (canceled)

43. A device comprising a strengthened glass substrate, wherein the substrate comprises:
a glass sheet having a thickness of 100 μm or less; and
a film comprising a volume expanded composition, the film being disposed on one or both surfaces of the glass sheet, wherein the film is under internal stress such that internal stress is imparted onto the glass sheet and a fracture strength of the glass sheet is improved.

44. The device of claim 43, wherein the film comprises polysiloxane, polycarbosilane, or an open-ring epoxy polymer.

45. (canceled)
